(19) United States
(12) Patent Application Publication
(10) Pub. No.: US 2006/0266322 A1
(43) Pub. Date: Nov. 30, 2006

(54) Piston for an internal combustion engine

(75) Inventors: Antonio Eduardo Meirelles Tomanik, Sao Paulo- Sp (BR); Clayton Barcelos Zabeu, Sao Paulo - Sp (BR); Germano Moreira De Almeida, Sao Paulo - Sp (BR); Jose Roberto Lopes, Sao Paulo - Sp (BR)

Correspondence Address: DARBY & DARBY P.C., P. O. BOX 5257, NEW YORK, NY, 10150-5257, US

(73) Assignee: Mahle Metal Leve S.A., Sao Paulo - SP (BR)

(21) Appl. No.: 11/443,661

(22) Filed: May 30, 2006

Related U.S. Application Data
(63) Continuation of application No. 10/495,397, filed on Oct. 6, 2004, now abandoned.

(30) Foreign Application Priority Data
Aug. 17, 2001 (BR) PI 0104909-7

(51) Int. Cl. F02F 3/00; B60T 11/236

(52) U.S. Cl. 123/193.4; 277/454

(57) ABSTRACT

The present invention provides a piston for an internal combustion engine. The design of the piston is such that the contact between the piston ring and the groove, during operation and especially in the moments of higher pressure on the ring, is as distributed as possible, in order to minimize the wear rate of the lateral walls of the groove.

### CROSS-REFERENCE TO RELATED APPLICATIONS

This application is a continuation of U.S. patent application Ser. No. 10/495,397, filed Oct. 6, 2004, which is a U.S. National Stage Application under 35 U.S.C. §371 of PCT International Application No. PCT/BR02/00115, filed Aug. 13, 2002, which claims priority to Brazilian Patent Application No. PI 0104909, filed Aug. 17, 2001. Each of these applications is incorporated herein by reference in its entirety.

### FIELD OF THE INVENTION

The present invention refers to a constructive solution for a piston of the type used in an internal combustion engine and, more particularly, to a constructive solution for the groove of such piston.

### BACKGROUND OF THE INVENTION

The piston ring of internal combustion engines presents, due to assembly or operational clearances, a relative movement in relation to the groove. Such relative movement, associated to the load imparted to the ring, mainly by the combustion gases, causes wear to the lateral faces of both the ring and the groove. In the groove located closer to the piston top, or first groove, where the loads are more severe, the ring is made of cast iron or steel, while the piston is of aluminum alloy, especially for Otto cycle engines. As the material of the piston is less wear resistant than that of the ring, more concern about wear is concentrated on the piston groove.

Under normal conditions, the wear of the first groove is of the order of few micrometers throughout the useful life of the engine, not impairing the engine's performance. In engines having severe operational conditions, in which the wear would be excessive, it is commonly used the solution of hard anodizing the region of the first groove, which solution creates a wear resistant hard flank, leading to acceptable wear values. However, such solution has the disadvantage of increasing the piston cost in about 20%.

In recent years, the increase in the engines' specific power has been associated to the use of rings made of nitrided steel, which, although bringing advantages as to the consumption of lubricant oil and the sealing of combustion gases, on the other hand can increase the groove wear, since the rings are harder than the cast iron. Thus, it has been more common to occur problems of excessive wear, consequently impairing the engine's performance, at least during the development phase of the engine. This wear problem has been solved by using nobler aluminum alloys and/or by hard anodizing the piston. However, both solutions increase the cost of the product or lead to the use of cast iron rings, avoiding the use of the significant advantages of employing rings of nitrided steel.

As mentioned above, it is possible to increase the wear resistance of the groove by using, in the piston, nobler and more wear resistant aluminum alloys, or by hard anodizing. Since the wear resistance of the aluminum is considerably reduced with temperature increase, some artifices to reduce the temperature may be used, especially in the region of the first groove. It is known to use spraying a lubricant through injecting nozzles located in the engine block in the internal region of the piston, in which case the lubricant oil functions as a refrigerant. It is also possible to locate the first groove more distant from the piston top, which reduces its temperature, but brings disadvantages as to the emission of pollutants by the engine.

Ideally, the lateral faces of both the ring and the groove of the piston should be parallel, so that the contact and the resulting pressures can be distributed, which minimizes the wear (FIG. 1). However, due to design characteristics, thermo-mechanical deformations of the piston, or to the relative angular movement between the ring and the piston, such contact occurs, in a contact region between the ring and the interior of the groove (FIG. 1a).

Due to the differentiated thermal expansion of the piston, higher at the top where the temperatures are higher, and lower towards its lower portion, which is commonly denominated piston skirt, the first groove tends to change its nominal design inclination, in a cold condition, to a higher inclination downwardly (FIG. 1a). Typical values of this inclination change are of the order of 10-15 minutes, in the anticlockwise direction, i.e., the groove, under operation, tends to change its nominal inclination to a higher inclination downwardly.

It is known to use pistons with grooves that are upwardly inclined in their nominal values. This is usually made to assure the ring will not contact the cylinder wall with its upper portion, which would be undesirable as to the scraping of lubricant oil by the ring. In addition to the thermal deformation of the groove, the piston moves angularly in relation to the pin, so that the resulting angle depends on the position of the pin along the height of the piston. This movement is shown in FIG. 2, in which the maximum displacement of the piston for each side of a plane that is orthogonal to the piston axis is illustrated. The maximum inclination of the piston as a whole is of about 10 minutes, and it can vary at each instant of the piston stroke. The effect of such inclination in groove wear is quite inferior to that resulting from groove inclination, which lasts throughout the piston stroke.

Due to the transient conditions found in the internal combustion engine, in which at each 1 degree interval of the crankshaft (which, for example, at 3,000 rpm is equivalent to about 0.06 millisecond), the ring/groove relative position, as well as the ring load on the groove, vary during the combustion stroke, as well as in each operational condition of the engine.

In a known prior art solution (JP-1182679), the lateral face of the ring is provided with the same angle of inclination as the groove under operation (FIG. 1B). In this construction, the ring has its lateral face with the same inclination as that of the groove under operation.

Rings having the lower lateral face inclined, as proposed in the document above, with either a trapezoidal or a semi-trapezoidal cross-section, are used in diesel engines to avoid sticking of the ring by the carbon deposited in the groove and present the disadvantage of having a much higher manufacturing cost than the rings with a rectangular section.

### OBJECT OF THE INVENTION

The object of the present invention is to provide a piston for an internal combustion engine, which allows the contact between the piston ring and the groove, during operation, especially in the moments of higher pressure on the ring, to be as distributed as possible, in order to minimize the wear rate of the lateral walls of said groove.

### SUMMARY OF THE INVENTION

This and other objects are achieved by a piston for an internal combustion engine of the type presenting circumferential grooves, each groove housing a respective piston ring and at least one first upper groove having a profile with upper and lower lateral walls that are radially outwardly inclined towards the piston top, by an angle of inclination such as to compensate, at least partially, the deformations to which the piston is submitted when in a critical higher load operational condition, in order to maximize the distribution of the seating contact between at least one of the upper and lower lateral faces of the ring and an adjacent lateral wall of the groove, as well as to minimize the wear that determines the useful life of the groove.

### BRIEF DESCRIPTION OF THE DRAWINGS

The invention will be described below, with reference to the appended drawings, in which:

FIGS. 1, 1a and 1b show, respectively and schematically, longitudinal vertical sectional views of prior art constructions of a piston for an internal combustion engine, mounted inside a cylinder and carrying, in a first groove, a respective piston ring, according to the prior art;

FIG. 2 is a vertical lateral view of a piston for an internal combustion engine, illustrating the directions of the angular displacement of said piston in relation to a plane orthogonal to the longitudinal axis of said piston;

FIG. 3 illustrates, schematically, the worn profile of the first groove of the piston, said groove being made according to the prior art illustrated in FIG. 1;

FIG. 4 illustrates, schematically, the profile of a groove constructed in accordance with the present invention; and

FIG. 4a illustrates, schematically, the worn profile of the piston groove constructed according to the present invention and illustrated in FIG. 4.

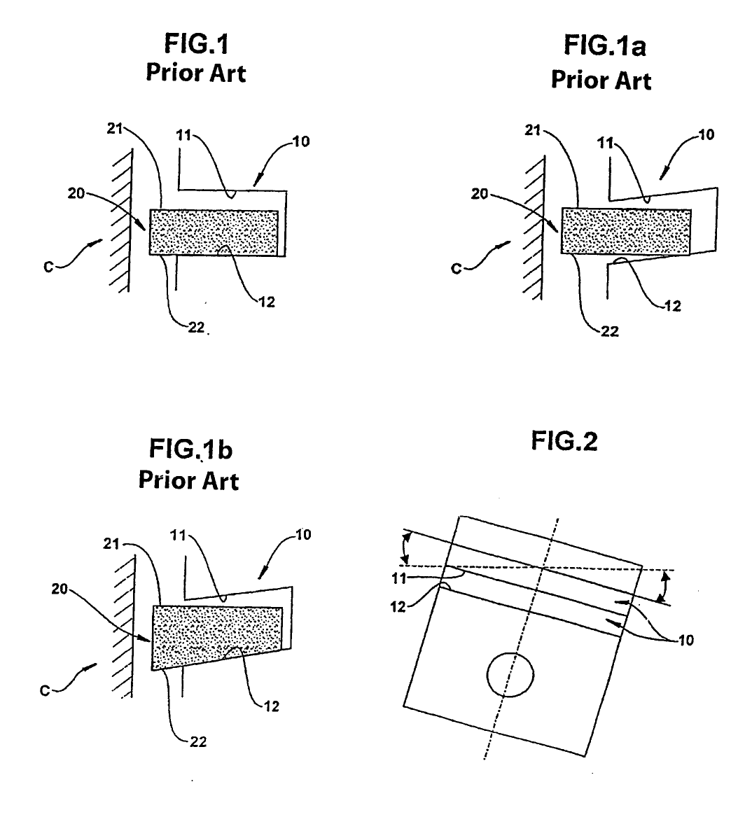

### DETAILED DESCRIPTION OF THE INVENTION

The present invention will be described in relation, for example, a piston designed to reciprocate inside a cylinder C of an internal combustion engine, and which is of the type illustrated in FIG. 2, usually made of aluminum or aluminum alloys and having a plurality of circumferential grooves 10, each groove 10 housing a respective piston ring 20.

The piston ring 20 is formed of a harder material than that of the piston, for example, steel, cast iron or a sintered metallic alloy, and generally presents an annular body having an upper lateral face 21 and a lower lateral face 22, which are opposite and generally parallel to each other and orthogonal to the axial axis of the ring, an internal face 23, and an external contact face 24 to be seated against an internal face of the cylinder C.

According to the present invention, at least the first groove 10 presents a profile with an upper lateral wall 11 and a lower lateral wall 12, which are radially outwardly inclined towards the piston top, by a nominal angle of inclination such as to compensate, at least partially, the deformations to which the piston is submitted when in a critical higher load operational condition, in order to maximize the distribution of the seating contact between at least one of the upper and lower lateral faces 21, 22 of the piston ring 20 and an adjacent lateral wall 11, 12 of the groove 10, as well as to minimize the wear that determines the useful life of the groove 10, particularly on the lower lateral wall 11 of said groove 10.

According to the present invention, the maximization of the contact distribution is achieved between the lower lateral wall 12 of the groove 10 and the adjacent lower lateral face 22 of the piston ring 20, said maximization condition occurring when the lower lateral wall 12 of the groove 10 is situated substantially coplanar with a plane orthogonal to the longitudinal axis of the piston and an adjacent lower lateral face 22 of the piston ring 20 is substantially seated on said lower lateral wall 12 of the groove 10, in the operational condition that determines the useful life of the groove 10.

In the illustrated construction, the first groove 10 has the respective upper and lower lateral walls 11, 12 parallel to each other and the piston ring 20 has its upper and lower lateral faces 21, 22 parallel to each other.

While the drawings illustrate only one constructive form for the upper and lower lateral faces 21, 22, it should be understood that they may have other configurations, such as defining, for example, a trapezoidal or semi-trapezoidal profile for said piston ring 20. It should be further understood that the upper and lower lateral walls 11, 12 of each groove 10 may equally have configurations other than being parallel to each other, as illustrated.

According to the present invention, the angle of inclination of the groove 10 is defined as a function of the mechanical and thermal characteristics of the piston and of the material with which it is formed, said thermal characteristics being determined by the coefficients of thermal transmission and thermal expansion of the piston material, and the mechanical characteristics of the piston ring being determined by the torsion and rigidity stiffness of the respective cross-section of the piston ring 20.

The achievement of the angle of inclination in accordance with the present invention also takes into account: the dynamics of the piston and piston ring 20 together, foreseeing the pressures that said piston ring 20 will exert against the lower lateral wall 12 of the groove 10 at each instant; the relative movement between each piston ring 20 and the respective groove 10; the wear rate of a portion of said lower lateral wall 12 of said groove 10; and the superficial roughness in one of the parts defined by the piston ring and the respective groove 10.

The wear between two pieces with relative movement is determined by the relation (Archard's law):
Q=(K·W/Hᵥ)ΔS
where:
Q: volume of the material removed by wear
K: wear coefficient of the system
W: applied normal load
Hᵥ: hardness, in Vickers, of the softer material
ΔS: sliding distance

Thus, it is possible to define the wear rate at each time interval during the combustion stroke, ΔWL (Wear Load), as:
ΔWL=Q/ΔS=(K·W)/Hᵥ
and the wear during the engine cycle as the summing up of the ΔWLs throughout the stroke. In a lubricated regime, like that of the ring/piston, part of the load W is supported by the hydrodynamic pressures of the lubricant film and these do not produce a significant wear.

The wear of the first groove 10 can be reduced by a groove/ring integrated design that minimizes the wear rate in the critical operational condition. Particularly, this design takes into account: the inclination change of the groove 10, due to the operational temperatures; the secondary movement of the piston around its pin; and the movement of the piston ring 20 in relation to the respective groove 10.

Since the piston profile when heated inclines downwardly in relation to the design position, the first groove 10, if this inclination change is not properly compensated, will have the contact of the respective piston ring 20 with the lower lateral wall 11 of the groove 10 occurring in a localized point, close to the inner bottom portion of said groove 10, starting an excessive wear process. In the initial stage, small craters appear near said inner bottom portion of the groove 10.

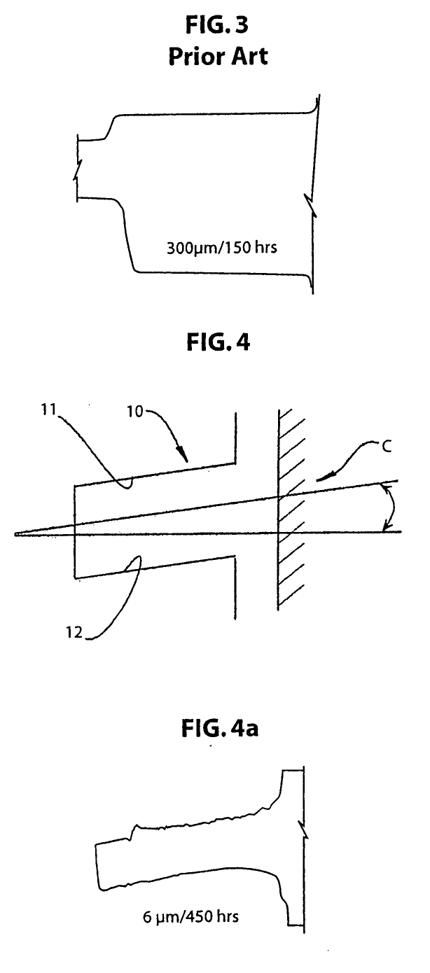

FIG. 3 illustrates a prior art groove 10 in which its bottom portion has been worn by the piston operating during a time interval of 150 hours, and in which the material resulting from this wear has been removed after said time interval has elapsed. The engine operation causes wear in the groove 10 that is propagated towards the edge of the latter, producing a step that can reach about 0.30 mm (FIG. 3), with prejudicial consequences to the engine's performance and even breaking the piston ring 20 or the piston itself.

In accordance with the present invention and as illustrated in FIGS. 4 and 4a, at least one groove 10 of the piston should present an angle of inclination turned upwardly, towards the piston top of about, for example, 5-30 minutes and preferably between 5 and 15 minutes, in order to compensate for the downward inclination that the groove suffers under operation. The specific value of this inclination depends on the properties of the piston material, such as thermal conductibility and coefficient of thermal expansion, on the critical or more significant operational conditional regarding wear rate, and on the dynamics of the piston ring 20.

The upward inclination of the groove 10 allows that, under operation in the selected operational condition, the dynamics and the lateral contact of an end lower face 22 of the piston ring 20 with the lower lateral wall 12 of the groove 10 results in a minimum wear rate.

The present invention has been tested in 3 gasoline engines and the result is presented in Table 1, in which is shown the maximum wear value found in the lower lateral wall 11 of the first groove 10, before and after design modifications. The engine identified as I began to present excessive wear of the groove 10 in the development phase period, when its power has been increased. Engines II and III use hard anodized pistons. The wear values shown in the original design refer to the values obtained with non-anodized pistons and maintaining the original design.

TABLE I
Maximum wear found in the lower flank of the 1^{st} groove (μm)

| | | |
|---|---|---|
| Engine | Original design | Optimized design |

| | | | |
|---|---|---|---|
| I | 1.0 L, 48 kW at | 10 μm after | 5 μm after |
| | 5,800 rpm | 150 hrs | 150 hrs |
| II | 1.6 L, 70 kW at | 30 μm after | 2 μm after |
| | 5,500 rpm | 150 hrs | 150 hrs |
| III | 1.0 L, 44 kW at | 300 μm after | 6 μm after |
| | 6,000 rpm | 150 hrs | 150 hrs |

As it can be noted in FIG. 4a, the profile of the groove 10 measured in the maximum wear position shows that the optimized design not only drastically reduced the wear of the groove 10, allowing the use of conventional aluminum piston alloys, but also demonstrate that the wear mechanism has been effectively altered. In the original design, the ring/groove contact was concentrated near the inner portion of the groove 10 whereas, after optimization, the worn profile of the groove 10 has less wear and localized adjacent to the open edge of said groove 10, defining a trumpet like shape to the latter.

1-11. (canceled)

12. A method for designing a piston for an internal combustion engine, the method comprising the steps of:
housing at least one piston ring having upper and lower lateral faces in a respective circumferential groove, the groove having an upper lateral wall and a lower lateral wall;
inclining the upper and lower lateral walls of the groove radially outward towards a piston top by an angle of inclination; and
determining the angle of inclination based upon mechanical and thermal characteristics of at least one of the piston ring, a piston, and a material that forms the piston ring.

13. The method as set forth in claim 12, further comprising the steps of:
compensating for a piston deformation that occurs when the engine is in a critical higher load operational condition; and
maximizing a distribution of a seating contact between at least one of the upper and lower lateral faces of the piston ring and an adjacent lateral wall of the groove.

14. The method as set forth in claim 13, wherein the maximizing step occurs between a lower lateral wall of the groove and an adjacent lower lateral face of the piston ring.

15. The method as set forth in claim 13, further comprising the step of:
situating the lower lateral wall of the groove on a plane that is substantially orthogonal to the longitudinal axis of the piston under operation conditions.

16. The method as set forth in claim 12, further comprising the step of:
disposing the upper lateral wall of the groove parallel to the lower lateral wall of the groove.

17. The method as set forth in claim 12, further comprising the step of:
disposing an upper lateral face of the piston ring parallel to a lower lateral face of the piston ring.

18. The method as set forth in claim 12, further comprising the step of:
determining the thermal characteristics of the piston based on coefficients of thermal transmission and thermal expansion of the piston material.

19. The method as set forth in claim 12, further comprising the step of:
determining the mechanical characteristics of the piston ring based on a torsion and rigidity stiffness of a respective cross-section of the piston ring.

20. The method as set forth in claim 12, further comprising the step of:
determining the mechanical characteristics of the piston ring based upon relative movements between the piston ring and the respective groove, and the superficial roughness in at least one of a part defined by the piston ring and the groove.

21. The method as set forth in claim 12, wherein the angle of inclination is approximately 5-30 minutes.

22. The method as set forth in claim 21, wherein the angle of inclination is approximately 5-15 minutes.

23. The method as set forth in claim 12, further comprising the step of:
determining the angle of inclination based upon a pressure that the piston ring exerts against the lower lateral wall of the groove.

24. The method as set forth in claim 12, further comprising the step of:
determining the angle of inclination based upon a relative movement between the piston ring and the groove.

25. The method as set forth in claim 12, further comprising the step of:
determining the angle of inclination based upon a wear rate of a portion of the lower lateral wall of the groove.

26. A method for determining an angle of inclination for a plurality of pistons each having a respective piston ring and a respective groove in an internal combustion engine, the method comprising the steps of:
evaluating a pressure that each of the respective piston rings will exert against a lower lateral wall of the respective groove at each instance of operation;
computing a relative movement between each of the respective piston rings and the respective groove; and
calculating a wear rate of a portion of the lower lateral wall of the respective groove.

27. The method as set forth in claim 26, wherein the wear rate at each time interval during a combustion stroke of the engine (ΔWL) is defined as:
$$Δ WL = \frac{Q}{Δ S} = \frac{K ⨯ W}{Hv} , where \text{:}$$
Q is the volume of the material removed by the wear;
K is the wear coefficient of the system;
W is the applied normal load;
Hᵥ is the hardness of the softer material (in Vickers); and
ΔS is the sliding distance.

28. The method as set forth in claim 26, further comprising the step of:
minimizing the wear of the respective groove by compensating for the inclination change of the respective groove due to operational temperatures, a secondary movement of each of the plurality of pistons around a respective pin, and a movement of each of the respective piston rings in relation to the respective groove.
